(19) United States
(12) Patent Application Publication
(10) Pub. No.: US 2007/0292644 A1
(43) Pub. Date: Dec. 20, 2007

(54) Process for Producing a Composite Material

(76) Inventors: Antonio Carrus, Milan (IT); Chlara Cipriani, Milan (IT); Lisa Grassi, Milan (IT); Stefano Testi, Milan (IT); Luca Castellani, Milan (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/667,942

(22) PCT Filed: Nov. 23, 2004
(86) PCT No.: PCT/EP04/13286

§ 371 Date: May 17, 2007

(51) Int. Cl. B29D 22/00; C08K 9/00

(52) U.S. Cl. 428/35.7; 523/216

(57) ABSTRACT

A process for producing a composite material includes the following steps: (a) melting at least one polyester having an inherent viscosity higher than or equal to 0.5 dl/g, preferably 0.6 dl/g to 1.2 dg/l; (b) cooling said polyester so as to obtain a polyester having a crystallinity lower than 30%, preferably 1% to 20%; and (c) mixing at least one layered clay material with the polyester obtained in step (b) so as to obtain the composite material. The composite material is particularly useful for manufacturing food or beverage containers, in particular bottles.

The present invention relates to a process for producing a composite material.

More particularly, the present invention relates to a process for producing a composite material comprising at least one polyester and at least one layered clay material.

Moreover, the present invention also relates to manufactured products, in particular food or beverage containers, more in particular bottles, comprising said composite material.

Polyesters such as poly(ethylene terephthalate) (PET) are widely used in bottles and containers which are used for carbonated beverages, fruit juices, and certain foods. Useful polyesters have high inherent viscosity (I.V.), which allows polyesters to be formed into parisons and subsequently molded into containers. Because of the poor barrier properties to oxygen,. carbon dioxide and the like, polyester containers are not generally used for products requiring long shelf life. For example, oxygen transmission into polyester bottles which contains beer, wine and certain food products causes these products to spoil.

There have been attempts to improve the barrier properties of polyester containers by use of multilayer structures comprising one or more barrier layers and one or more structural layers of polyester. However, multilayer structures have not found wide use and are not suitable for use as a container for beer due to high cost, the large thickness of the barrier layer required and the poor adhesion of the barrier layer to the structural layer.

Recently, there is much interest in polymer/layered clay composite materials because of the improved properties, in particular barriers properties (gas permeability), exhibited by said composite materials.

In order to obtain composite materials having said improved properties, in particular barrier properties, and to minimize deleterious effects on some properties including elongation at break, it is desirable to maximize delamination of the layered clay material into individual platelet particles. Ideally, the clay material is exfoliated into platelet particles with a thickness of less than about 20 nm in order to achieve clarity that is comparable to the clay-free polymer.

There are many examples in the art of polymer/layered clay composite materials having improved barrier properties.

For example, U.S. Pat. No. 5,962,553 relates to nanocomposites which are made by melt-blending a melt processable polymer having a high melt processing temperature and an organophosphonium cation modified layered clay. Melt processable polymer which may be used include fluoroplastics, poly(phenylene ether ketones), aliphatic polyketones, polyesters, poly(phenylene sulfides) (PPS), poly(phenylene ether sulfones) (PES), poly(ether imides), poly(imides), polycarbonates, and the like. The abovementioned nanocomposites are said to have increased stiffness without a significant reduction in elongation at break, reduced vapor permeability, and improved heat stability without any noticeable change in the thermoplastic's crystallinity caused by the conventional fillers.

U.S. Pat. No. 6,084,019 relates to a polymer composite composition comprising about 0.01 to about 25 weight percent based on the weight of the composition of a clay materials having a cation exchange capacity between about 0.3 and about 3 meq/g comprising platelet particles dispersed in at least one polyester wherein the majority of said platelet particles have a thickness in the shortest dimension of less than about 20 nm and wherein said composition is solid state polymerized and has an inherent viscosity (I.V.) of greater than about 0.5 dl/g, low shear melt viscosity greater than about 25,000 poise and a gas permeability which is at least 10% lower than that of unmodified polyester. The abovementioned composition is said to be useful for making articles such as films, tubes, pipes, containers, particularly stretch blow molded and extrusion blow molded containers and films.

International Patent Application WO 01/72881 relates to a polyester-based composition having improved thermomechanical properties comprising a polyester-based matrix and nanometrical-sized mineral particles having a shape factor comprised between 1 and 10, at a weighted concentration within 0.01% and 25%. The abovementioned composition is said to be particularly useful for manufacturing bottles.

U.S. Pat. No. 6,486,252 relates to a composition comprising (i) a layered clay material that has been cation-exchanged with an organic cation salt represented by the following formula: 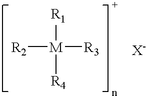
wherein M is nitrogen or phosphourus, X⁻ is a halide, hydroxide, or acetate anion, R₁ is a straight or branched alkyl group having at least 8 carbon atoms, and R₂, R₃, and R₄ are independently hydrogen or a straight or branched alkyl group having 1 to 22 carbon atoms; and (ii) at least one expanding agent, wherein the cation-exchanged clay material contains platelet particles and the expanding agent separates the platelet particles. Moreover, the US patent also relates to a composite comprising a polymer, preferably a polyester, having dispersed therein the abovementioned composition. The abovementioned composite is said to have improved barrier properties.

U.S. Pat. No. 6,486,253 relates to a polymer-clay nanocomposite having an improved gas barrier comprising: (i) a melt processable matrix polymer and incorporated therein (ii) a clay-organic cation intercalated with a mixture of at least two organic cations, wherein (a) at least 75% of the layered clay material is dispersed in the form of individual platelet particles and tactoids having a thickness of less than or equal to 20 nm in the matrix polymer, (b) the organic cations comprises a mixture of polyalkoxylated ammonium ions and the polyalkoxylated ammonium ions are derived from an oligooxyethylene amine, an oligooxypropylene amine, an octadecyl methyl bis(polyoxyethylene[15])ammonium salt, or octadecyl methyl bis(polyoxyethylene[15])amine, wherein the numbers in brackets are the average of the total number of ethylene oxide units. The melt-processable matrix polymer may be selected from: polyesters, polyetheresters, polyamides, polyesteramides, polyurethanes, polyimides, polyetherimides, polyureas, polyamideimides, polyphenyleneoxydes, phenoxy resins, epoxy resins, polyolefins, polyacrylates, polystyrenes, polyethylene-co-vinyl alcohols, or copolymers thereof, or a mixtures thereof.

U.S. Pat. No. 6,552,113 relates to a polymer-clay nanocomposite comprising: (a) a matrix polymer; (b) an amorphous oligomer; and (c) a layered clay material, or residue thereof. The matrix polymer may be selected from: polyesters, polyetheresters, polyamides, polyesteramides, polyurethanes, polyimides, polyetherimides, polyureas, polyamideimides, polyphenyleneoxydes, phenoxy resins, epoxy resins, polyolefins, polyacrylates, polystyrenes, polyethylene-co-vinyl alcohols, or copolymers thereof, or a mixtures thereof. The amorphous oligomer may be selected from oligomeric polyamides and/or polyesters. The use of said amorphous oligomer is said to overcome the nucleating effect caused by the presence of clay platelet particles and to provide a polymer-clay composite having improved processability in blow-molding applications, improved adhesion, improved recyclability, improved color, improved barrier, improved clarity, and/or their combination.

The abovementioned polymer/layered clay composite materials may be produced by means of different processes.

For example, said polymer/layered clay composite materials may be produced by incorporation of the layered clay during synthesis of the polymer from monomers. However, it is widely known that the amount of layered clay that may be admixed in a polymer and still exhibit exfolation of the layered clay is limited and some mechanical properties, such as elongation at break, are often reduced considerably upon the addition of the layered clay.

Alternatively, polymer/layered clay composite materials may be produced by melt blending a layered clay with a polymer. However, with many polymer/clay mixtures, the melt-compounding processes explored to date does not provide sufficient exfoliation of the platelet particles.

Moreover, when a conventional quaternary ammonium cation modified layered clay is used, it is difficult to produce polymer/layered clay composite materials with a melt processed polymer such as a crystalline thermoplastic having high crystalline melting temperature or an amorphous polymer having a high glass transition temperature, because said modified layered clay is stable only up to about 250° C.

Furthermore, said conventional processes may allow to obtain composite materials showing poor appearance, mainly due to the formation of defects on their surface such as, for example, little agglomerates, which impair not only their appearance and smoothness but also their mechanical and/or barrier properties.

The Applicant has now found that it is possible to overcome the above reported drawbacks by a process for producing a composite material comprising at least one polyester and at least one layered clay material, wherein the layered clay material is incorporated into a polyester in a substantially amorphous phase, i.e. a polyester having a % crystallinity lower than 30%. In particular, the Applicant has found that the use of said polyester in a substantially amorphous phase allows to achieve an effective exfoliation of the layered clay material so as to obtain a composite material having improved barrier properties. Moreover, said process allow to work at low temperatures so avoiding a possible decomposition of the modified layered clay material which may be used. Furthermore, said process allow to obtain a composite material showing good appearance and improved mechanical properties and/or barrier properties. Said composite material is particularly useful in the production of food or. beverage containers, more in particular bottles. In particular, said composite material allows to manufacture, for example by injection molding, preforms which are essentially non-crystalline in character which are subsequently formed into containers which are essentially crystalline in character. According to a first aspect, the present invention relates to a process for producing a composite material comprising the following steps:
(a) melting at least one polyester having an inherent viscosity (I.V.) higher than or equal to 0.5 dl/g, preferably of from 0.6 dl/g to 1.2 dg/l;
(b) cooling said polyester so as to obtain a polyester having a % of crystallinity lower than 30%, preferably of from 1% to 20%;
(c) mixing at least one layered clay material to the polyester obtained in step (b) so as to obtain the composite material.

Said % of crystallinity may be determined by the following formula:
% crystallinity=(ΔHₘ−ΔH_{c})/(Δ⁰Hₘ)*100
wherein:
ΔHₘ is the melting enthalpy corresponding to the melting peak detected on the first heating cycle of the polyester obtained in step (b);
ΔH_{c} is the crystallization enthalpy corresponding to the crystallization peak detected on the first heating cycle of the polyester obtained in step (b);
Δ⁰Hₘ is the melting enthalpy relating to the melting peaks detected on the first heating cycle of the crystalline polyester used in step (a).

Said melting enthalpy (ΔHₘ and Δ⁰Hₘ) and said crystallization enthalpy (ΔH_{c}) may be measured according to known techniques such as, for example, by Differential Scanning Calorimetry (DSC): further details regarding the DSC analysis will be described in the examples given hereinbelow.

According to one preferred embodiment, said process may further comprises a crystallization step (d).

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

According to one preferred embodiment, the ratio between the inherent viscosity (I.V.) of the obtained composite material and the inherent viscosity of the starting polyester used in step (a) is not higher than 1, preferably of from 0.7 to 0.9.

Said inherent viscosity is measured according to ASTM Standard D4603-91: further details regarding the inherent viscosity measurement will be described in the examples given hereinbelow.

The process according to the present invention may be carried out in one-step or in two-steps.

The process according to the present invention may be carried out in any mixing device known in the art. Preferably, the mixing device may be selected from: open internal mixers such as, for example, open-mills; internal mixers such as, for example, Haake Rheocord internal mixer, or internal mixers of the type with tangential rotors (Banbury) or with interlocking rotors (Intermix); continuous mixers of Ko-Kneader type (Buss); co-rotating or counter-rotating twin-screw extruders. More preferably, the mixing device is a co-rotating twin-screw extruder.

According to one preferred embodiment, said melting step (a) is carried out at a temperature of from 150° C. to 350° C., preferably of from 200° C. to 300° C.

According to one preferred embodiment, said melting step (a) is carried out for a time of from 5 seconds to 15 minutes, preferably of from 10 seconds to 10 minutes.

The above reported cooling step (b) may be carried out in different ways depending on the fact that the process above reported is carried out in one-step or in two-steps.

According to one preferred embodiment, when the process is carried out in one-step, said cooling step (b) is carried out to reach a temperature higher than the crystallization temperature (T_{c}) of the polyester used in step (a), but lower than the melting temperature (Tₘ) of the polyester used in step (a), preferably in a temperature range of from (Tₘ-120° C.) to (Tₘ-20° C.), more preferably of from (Tₘ-100° C.) to (Tₘ-40° C.)

According to one preferred embodiment, said cooling step (b) is carried out for a time of from 2 seconds to 10 minutes, preferably of from 5 seconds to 5 minutes.

Said cooling step (b) is carried out directly in the mixing device used in step (a).

According to one preferred embodiment, when the process is carried out in two-steps, said cooling step (b) is carried out to reach a temperature lower than the crystallization temperature (T_{c}) of the polyester used in step (a), preferably in a temperature range of from (T_{c}-120° C.) to (T_{c}-20° C.), more preferably of from (T_{c}-100° C.) to (T_{c}-40° C.)

According to one preferred embodiment, said cooling step (b) is carried out for a time of from 2 seconds to 60 seconds, preferably of from 3 seconds to 30 seconds.

Said cooling step (b) is carried out by means of cooling devices (for example, a water bath) and cooling medium (for example, cold air, water, or any other fluid able to cause a sudden cooling of the polyester such as, for example, refrigerating oils) known in the art.

Said melting temperature and said crystallization temperature may be measured according to known techniques such as, for example, by Differential Scanning Calorimetry (DSC): further details regarding the DSC analysis will be described in the examples given hereinbelow.

According to one preferred embodiment, said mixing step (c) is carried out at a temperature of from 20° C. to 160° C., preferably of from 30° C. to 120° C.

According to one preferred embodiment, said mixing step (c) is carried out for a time of from 2 seconds to 15 minutes, preferably of from 3 seconds to 10 minutes.

As reported above, the process according to the present invention may further comprise a crystallization step (d).

According to one preferred embodiment, said crystallization step (d) is carried out by cooling the composite material obtained in step (c) in a temperature range of from the glass transition temperature (T_{g}) to the crystallization temperature (T_{c}) of the polyester obtained in step (b), with a cooling speed of from 1° C./min to 20° C./min, preferably of from 2° C./min to 10° C./min. Advantageously, in order to obtain a high % crystallinity, during said crystallization step (d), the composite material obtained in step (c) is subjected to mechanical work (for example, to strecth by blow molding).

Said glass transition temperature (T_{g}) and said crystallization temperature (T_{c}) may be measured according to known techniques such as, for example, by Differential Scanning Calorimetry (DSC): further details regarding the DSC analysis will be described in the examples given hereinbelow.

According to one preferred embodiment, the polyester which may be used in step (a) of the process according to the present invention has a melting point higher than 200° C., preferably of from 210° C. to 270° C.

According to one preferred embodiment, said polyester has a melting enthalpy (ΔH⁰ₘ) higher than or equal to 10 J/g, preferably of from 15 J/g to 180 J/g.

Said melting enthalpy (Δ⁰Hₘ) may be determined by Differential Scanning Calorimetry (DSC): further detailε regarding the DSC analysis will be described in the examples given hereinbelow.

According to one preferred embodiment, the polyester which may be used in step (a) of the process according to the present invention may be selected from polyesters including at least one dibasic acid and at least one glycol. The primary dibasic acid may be selected from: terephthalic acid, isophthalic acid, naphthalenedicarboxylic acid, 1,4-cyclohexanedicarboxylic acid, or mixtures thereof. The various isomers of naphthalenedicarboxylic acid or mixtures of isomers may be used, but the 1,4-, 1,5-, 2,6-, and 2,7-isomers are preferred. The 1,4-cyclohexanedicarboxylic acid may be in the form of cis, trans, or cis/trans mixtures. In addition to the acid forms, the lower alkyl esters or acid chlorides may also be used.

The dicarboxylic acid component of the polyester may optionally be modified with up to 50 mole percent of one or more different dicarboxylic acids. Such additional dicarboxylic acids include dicarboxylic acids having from 3 to 40 carbon atoms, and more preferably dicarboxylic acids selected from aromatic dicarboxylic acids preferably having from 8 to 14 carbon atoms, aliphatic dicarboxylic acids preferably having from 4 to 12 carbon atoms, or cycloaliphatic dicarboxylic acids preferably having from 7 to 12 carbon atoms. Examples of suitable dicarboxylic acids include phthalic acid, isophthalic acid, naphthalene-2,6-dicarboxylic acid, cyclohexanedicarboxylic acid, cyclohexanediacetic acid, diphenyl-4,4′-dicarboxylic acid, phenylenedi(oxyacetic acid), succinic acid, glutaric acid, adipic acid, azelaic acid, sebacic acid, or mixtures thereof. Polyesters may be prepared from one or more of the above dicarboxylic acids.

Typical glycols used in the polyester include aliphatic glycols containing from 2 to 10 carbon atoms, aromatic glycols containing from 6 to 15 carbon atoms, cycloaliphathic glycols containing from 7 to 14 carbon atoms, or mixtures thereof. Preferred glycols include ethylene glycol, 1,4-butanediol, 1,6-hexanediol, 1,4-cyclohexanedimethanol, diethylene glycol, or mixtures thereof. Resorcinol and and hydroquinone are preferred glycols for producing fully aromatic polyesters. The glycol component may be optionally modified with up to 50 mole percent, preferably up to 25 mole percent, and more preferably up to 15 mole percent, of one or more different diols. Such additional diols include cycloaliphatic diols preferably having from 3 to 20 carbon atoms or aliphatic diols preferably having from 3 to 20 carbon atoms. Examples of such diols include: diethylene glycol, triethylene glycol, 1,4-cyclohexanedimethanol, propane-1,3-diol, butane-1,4-diol, pentane-1,5-diol, hexane-1,6-diol, 3-methylpentanediol-(2,4), 2-methylpentanediol-(1,4), 2,2,4-trimethylpentane-diol-(1,3), 2-ethylhexanediol-(1,3), 2,2-diethylpropane-diol-(1,3), hexanediol-(1,3), 1,4-di(2-hydroxyethoxy)benzene, 2,2-bis(4-hydroxycyclo-hexyl)propane, 2,4-dihydroxy-1,1,3,3-tetramethylcyclo-butane, 2,2-bis(3-hydroxyethoxyphenyl)propane, 2,2-bis-(4-hydroxypropoxyphenyl)propane, or mixtures thereof. Polyesters may be prepared from one or more of the above diols.

Difunctional components such as hydroxybenzoic acid may also be used. Also small amounts of multifunctional polyols such as trimethylolpropane, pentaerythritol, glycerol, or mixtures thereof, may be used, if desired. When using 1,4-cyclohexanedimethanol, it may be cis, trans or cis/trans mixtures. When using phenylenedi(oxyacetic acid) it may be used as 1,2-, 1,3-, 1,4-isomers, or mixtures thereof

Said polyester may also contain small amounts of trifunctional or tetrafunctional comonomers to provide controlled branching in the polymers. Such comonomers include trimellitic anhydride, trimethylolpropane, pyromellitic dianhydride, pentaerythritol, trimellitic acid, pyromellitic acid and other polyester forming polyacids or polyols generally known in the art.

If necessary, the polyester may further comprises additives conventionally used in polymers. Examples of such additives are: colorants, pigments, carbon black, glass fibers, fillers, impact modifiers, antioxidants, stabilizers, flame retardants, reheat aids, crystallization aids, acetaldehyde reducing compounds, recycling release aids, oxygen scavengers, plasticizers, nucleators, mold release agents, compatibilizers, or mixtures thereof.

Said polyesters may be obtained by means of processes known in the art such as, for example, through polycondensation of at least one diol and at least one dicarboxylic acid above disclosed.

According to one preferred embodiment, the polyester which may be used in step (a) of the process according to the present invention may be selected from: poly(ethylene terephthalate) (PET), poly(trimethylene terephthalate), poly(butylene terephthalate) (PBT), poly(naphthalene terephthalate), copolymers or mixtures thereof. Poly(ethylene terephthalate) is particularly preferred.

Examples of polyesters which may be used in step (a) of the process according to the present invention and are available commercially are the products known by the name of Voridian® PET from Voridian.

According to one preferred embodiment, the layered material which may be used in step (c) of the process according to the present invention has an individual layer thickness of from 0.01 nm to 30 nm, more preferably of from 0.05 nm to 15 nm.

According to one preferred embodiment, the layered clay material which may be used in step (c) of the process according to the present invention may be selected, for example, from natural, synthetic, or modified phyllosilicates. Natural clays include, for example, smectites clays such as, for example, montmorillonite, saponite, hectorite, mica, vermiculite, bentonite, nontronite, beidellite, volkonskoite, magadite, kenyaite, or mixtures thereof. Synthetic clays include, for example, synthetic mica, synthetic saponite, synthetic hectorite, or mixtures thereof. Modified clays include, for example, fluoronated montmorillonite, fluoronated mica, or mixtures thereof. Montmorillonite is particularly preferred.

Generally, the layered clay material which may be used in step (c) of the process according to the present invention is an agglomeration of individual platelet particles that are closely stacked together like cards, in domains called tactoids; Polyester/layered clay composite materials with the higher concentration of individual platelet particles and fewer tactoids or aggregates are preferred.

Moreover, the layered clay material is typically swellable free flowing powder having a cation exchange capability of from 0.3 to 3.0 milliequivalent per gram of mineral (meq/g), preferably of from 0.90 meq/g to 1.5 meq/g. The layered clay material may have a wide variety of exchangeable cations present in the galleries between the layers of the clay including, for example, cations comprising the alkaline metals (group IA), the alkaline earth metals (group (IIA), or mixtures thereof. The most preferred cation is sodium, however any cation or combination of cations may be used, provided that most of the cations may be exchanged for organic cations (onium ions). The exchange may occur by treating a individual clay or a mixtures of clay with organic cations.

Prior to incorporation into the polyester, the particle size of the layered clay material may be reduced in size by methods known in the art such as, for example, grinding, pulverizing, hammer milling, jet milling, or their combinations. As a matter of fact, it is preferred to use layered clay materials having an average particle size lower than 100 μm, preferably lower than 50 μm, more preferably of from 5 μm to 20 μm.

As disclosed above, in order to render the layered clay material more compatible with the polyester base, said layered clay material may be treated with a compatibilizing agent capable of generating organic cations.

According to one preferred embodiment, said compatibilizing agent may be selected, for example, from quaternary ammonium or phosphonium salts having general formula (I): 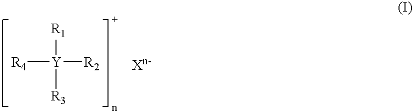
wherein:
Y represents N or P;
R₁, R₂, R₃ and R₄, which may be identical or different, represent organic and/or oligomeric ligands or an hydrogen atom;
Xⁿ⁻ represents an anion such as the chlorine ion, the sulphate ion, the phosphate ion, the hydroxide ion, or the acetate ion;
n represents 1, 2 or 3.

Examples of organic ligands are: linear or branched C₁-C₂₂ alkyl or hydroxyalkyl groups; linear or branched Cₗ-C₂₂ alkenyl or hydroxyalkenyl groups; groups -—R₅—SH or —R₅—NH wherein R₅ represents a linear or branched C₁-C₂₂ alkylene group; C₆-C₁₈ aryl groups; arylalkyl or alkylaryl groups such as, for example, benzyl or substituted benzyl group included fused-ring groups having linear chains or branched chains containing from 1 to 100 carbon atoms; C₅-C₁₈ cycloalkyl groups, said cycloalkyl groups possibly containing hetero atom such as oxygen, nitrogen or sulphur.

Examples of oligomeric ligands are: poly(alkylene oxide), polystyrene, polyacrylate, polycaprolactone, or mixtures thereof.

According to one preferred embodiment, the compatibilizing agent is selected from quaternary ammonium compounds having formula (I) wherein at least one from R₁, R₂, R₃ and R₄ substituents represents a arylalkyl or a alkylaryl group.

Specific example of compatibilizing agent which may be advantageously used in step (c) of the process according to the present invention are: dimethyl benzyl hydrogenated tallow ammonium, hexyl benzyl dimethyl ammonium, benzyl trimethyl ammonium, butyl benzyl dimethyl ammonium, or mixtures thereof.

The layered clay material may be treated with the compatibilizing agent before adding it to the polyester. Alternatively, the layered clay material may be treated with the compatibilizing agent during or after the mixing with the polyester.

The treatment of the layered clay material with the compatibilizing agent may be carried out according to known methods such as, for example, by an ion exchange reaction between the layered inorganic material and the compatibilizing agent: further details are described, for example, in U.S. Pat. No. 4,136,103, U.S. Pat. No. 5,747,560, or U.S. Pat. No. 5,952,093.

The layered clay material may be further treated for the purposes of improving the exfoliation in the composite material and/or improving the strenght of the polyester/clay interface. Examples of useful treatments include intercalation with water-soluble or water-insoluble polymers or oligomers, organic reagents or monomers, silane compounds, metal or organometallics, and/or their combinations. Treatment of the clay may be accomplished prior to the addition of the layered clay to the polyester, during or after the mixing with the polyester.

Examples of treatments with polymers or oligomers may be found, for example, in U.S. Pat. No. 5,552,469, or U.S. Pat. No. 5,578,672. Examples of useful polymer for treating the layered clay material include polyvinyl pyrrolidone, polyvinyl alcohl, polyethylene glycol, polytetrahydrofuran, polystyrene, polycaprolactone, certain water-dispersable polyesters, nylon-6, or mixtures thereof.

Example of treatments with organic reagents or monomers may be found, for example, in European Patent Application EP 780,340. Examples of useful organic reagents or monomers for treating the layered clay material include dodecylpyrrolidone, caprolactone, caprolactam, ethylene carbonate, ethylene glycol, bis-hydroxyethyl terephthalate, dimethyl terephthalate, or mixtures thereof.

Example of treatments with organic silane compounds may be found, for example, in International Patent Application WO 93/11190. Examples of useful silane compounds for treating the layered clay material include (3-glycidoxypropyl)trimethoxysilane, 2-methoxy(polyethyleneoxy)propyl heptamethyl trisiloxane, octadecyl dimethyl(3-trimethoxysilylpropyl)ammonium chloride, or mixtures thereof.

Alternatively, said layered material may be selected from layered double hydroxides (LDH). These materials are the so-called anionic clays consisting of small crystalline sheets of dimensions of a few nanometers between which anion is located. By these anions are meant anions other than hydroxyl groups. The layered double hydroxides may be both natural and synthetic. More details about said layered double hydroxides may be found, for example, in U.S. Pat. Nos. 3,539,306 and 3,650,704 and in International Patent Application WO 99/35185.

Example of layered clay material which may be used in step (c) of the process according to the present invention and is available commercially are the products known by the name of Dellite® from Laviosa Chimica Mineraria S.p.A.

According to one preferred embodiment, the layered clay material is present in the composite material in an amount of from 0.01 phr to 25 phr, preferably of from 0.5 phr to 15 phr.

For the aim of the present description and of the claims which follow, the term “phr” means the parts by weight of a given component per 100 parts of polyester.

To the composite material above disclosed additional compounds such as, for example, fillers, additives and reagents, may be added. Examples of additives and reagents which may be used are: adhesive modifiers, oxygen scavenging catalysts, oxygen scavengers, toners, dyes, coloring agents, UV absorbers, mold release agents, impact modifiers, or mixtures thereof. Examples of fillers which may be used are: glass fibers, glass beads, talc, carbon black, carbon fibers, titanium dioxide, or mixtures thereof.

The present invention will now be illustrated in further detail by means of a number of illustrative embodiments, with reference to the attached figures wherein:

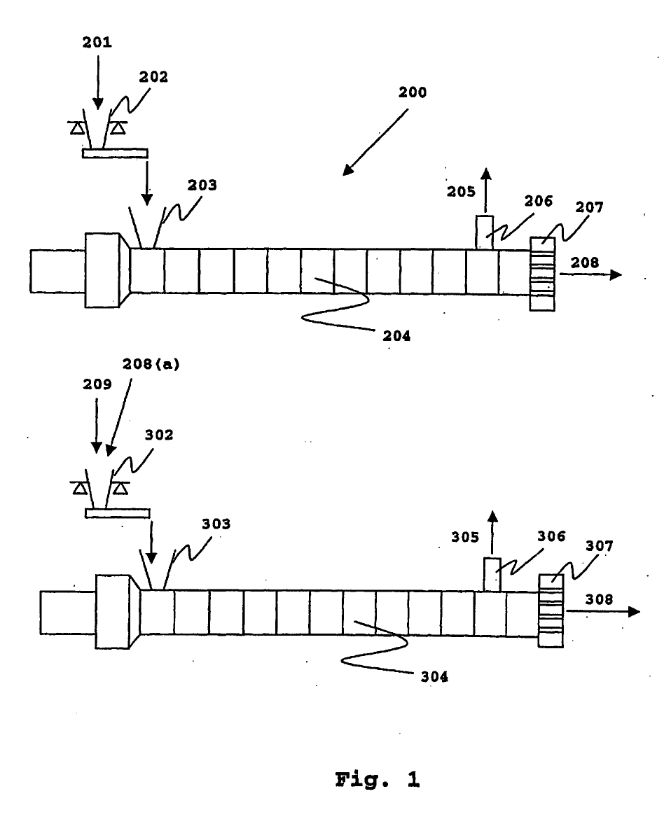

FIG. 1 is a schematic diagram of a production plant for producing a composite material according to the present invention (two-steps process);

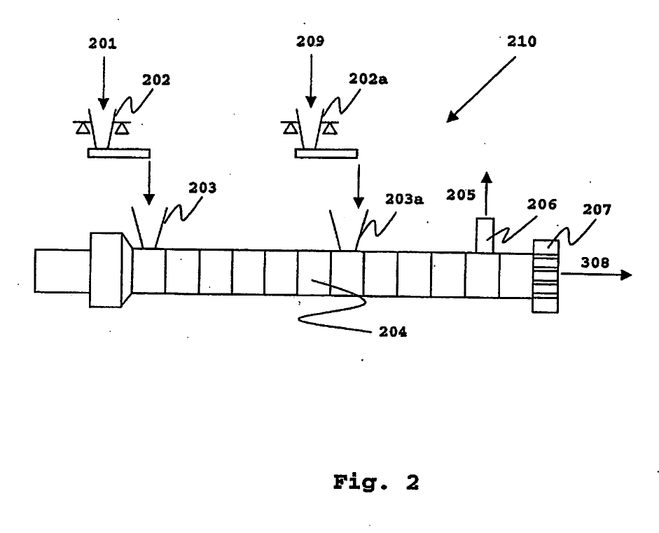

FIG. 2 is a schematic diagram of a further embodiment of a production plant for producing a composite material according to the present invention (one-step process).

FIG. 1 refer to a two-step process. With reference to FIG. 1, the production plant (200) includes an extruder (204) suitable for producing a molten polyester (208). As schematically shown in FIG. 1, by means of a feed hopper (203), the extruder (204) is fed with the polyester (201).

Preferably, the extruder (204) is a co-rotating twin screw extruder.

The polyester (201) is fed to the feed hoppers (203) by means of a metering device (202). Preferably, said metering device (202) is a loss-in-weight gravimetric feeder.

The polyester may be fed to the extruder in distinct portions, for example the polyester may be fed to two or more distinct zones of the extruder.

FIG. 1 shows also a degassing unit schematically indicated by reference sign (206) from which a flow (205) exits.

The molten polyester (208) is discharged from the extruder (204), e.g in the form of continuous strands by pumping it through an extruder die (207). A gear pump (not represented in FIG. 1) may be provided before said extruder die (207). The extruded strands are suddendly cooled in a cooling device such as, for example, a water bath (not represented in FIG. 1), dried by means of a drying device (not represented in FIG. 1) and granulated by means of a grinding device (not represented in FIG. 1) to obtain a polyester having a % of crystallinity lower than 30%, preferably of from 1% to 20% (hereinafter referred to as “polyester in a substantially amorphous phase”) in a subdivided form (208a). Alternatively, the polyester in a substantially amorphous phase in a subdivided form (208a) may be directly obtained by pumping the molten polyester (208) through an extruder die (207) provided with a perforated die plate equipped with an underwater pellettizing device (not represent in FIG. 1). The obtained polyester in a subdivided form may be then dried by means of a drying device (not represented in FIG. 1).

The so obtained polyester in a substantially amorphous phase (208a) and the layered clay material (209), are then fed to a second extruder (304). To this end, the polyester in a substantially amorphous phase (208a) obtained as disclosed above and the layered clay material (209), are fed to a second extruder through a feed hopper (303) by means of a metering device (302).

Alternatively, the obtained polyester in a substantially amorphous phase (208a) and the layered clay material (209), may be fed through different feed hoppers by means of different metering devices (not represented in FIG. 1).

FIG. 1 shows also a degassing unit schematically indicated by reference sign (306) from which a flow (305) exits.

The composite material (308) is discharged from the extruder (304) by pumping it through an extruder die (307) in the form of continuous strands which may be transformed into a product in a subdivided form operating as disclosed above (not represented in FIG. 1). A gear pump (not represented in FIG. 1) may be provided before said extruder die (307).

FIG. 2 refers to one-step process. FIG. 2 is a further embodiment of a production plant (210) wherein the process according to the present invention is carried out by means of a single extruder (204). To this end the polyester (201) is fed to the extruder (204) through a feed hopper (203) by means of a metering device (202).

After melting and cooling the polyester in order to obtain a polyester in a substantially amorphous phase, the layered clay material (209) is fed to the extruder (204) through a second feed hopper (203a) by means of a second metering device (202a).

FIG. 2 shows also a flow (205) exiting from the extruder (204) which is generally provided with a degassing unit schematically indicated by reference sign (206).

The composite material (308) is discharged from the extruder (204) in the form of continuous strands which may be transformed into a product in a subdivided form operating as disclosed above (not represented in FIG. 2). A gear pump (not represented in FIG. 2) may be provided before said extruder die (207).

The composite material obtained as above disclosed may be formed into manufactured products by conventional plastic processing techniques. For example, compression molding, blow molding, vacuum molding, injection molding, calendering, casting, extrusion, filament winding, laminating, rotational or slush molding, transfer molding, lay-up or contact molding, stamping, or combinations of these methods, may be used. Monolayer and/or multilayers manufactured products prepared from the composite material above disclosed include: films, sheets, pipes, tubes, profiles, molded articles, preforms, stretch blow molded films and containers, injection blow molded containers, extrusion blow molded films and containers, thermoformed articles, and the like. Monolayer manufactured products are preferred. The containers are, preferably, food or beverage containers, more preferably bottles.

The food or beverage containers so obtained provide increased shelf storage life for contents, including beverages and food that are sensitive to the permeation of gases. The manufactured products, more preferably containers, of the present invention display a gas transmission or permeability rate (oxygen, carbon dioxide, water vapor) of at least 5% lower, preferably of from 7% to 90% lower, than that of similar containers made from clay-free polyester, resulting in a correspondingly longer product shelf life provided by the container. Both the modulus and tensile strenght are not negatively affected. The manufactured. products also show unexpected resistance to haze formation, crystallization, and other defects formation.

As already above disclosed, the manufactured products may be monolayer, two-layers or multilayers. Preferably, the multilayers manufactured products have a composite material disposed intermediate to other layers. In embodiments where the composite material is approved for food contact, said composite material may form the food contact layer of the desired manufactured products. In other embodiments, it is preferred that the composite material be in a layer other than the food contact layer.

The multilayers manufactured products may also contain one or more layers of the composite material of the present invention and one or more layers of a structural polymer. Example of structural polymers which may be advantageously used are: polyesters, polyetheresters, polyamides, polyesteramides, polyurethanes, polyimides, polyetherimides, polyureas, polyamideimides, polyphenyleneoxides, phenoxy resins, epoxy resins, polyolefins, polyacryaltes, polystyrenes, polyethylene-co-vinyl acohols (EVOH), or mixtures thereof. The preferred structural polymers are polyesters such as, for example, poly(ethylene terephthalate) and its copolymers.

In another embodiment, manufactured products may be obtained by co-extruding a layer of the composite material above disclosed with some other suitable thermoplastic resins. The composite material (polyester/clay composite), the molded manufactured product and/or the extruded sheet, may also be formed at the same time by co-injection molding or co-extruding.

Another embodiment is the combined use of layered clay materials uniformly dispersed in the matrix of a high barrier thermoplastic together with the multilayer approach to packaging material. By using a layered clay material to decrease the gas permeability in the high barrier layer, the amount of this material that is needed to generate a specific barrier level in the end application is greatly reduced.

In forming strecth blow molded bottles of one or several layers, it is often customary to initially form a preform of the desired vessel via injection molding process. The crystallization rate of the materials comprising the preform must be sufficiently slow to allow the formation of an essentially non-crystalline article. Unless the preform is essentially non-crystalline, it is exceedingly difficult to stretch blow mold into the desired shape to form a bottle. In an embodiment of this invention, the layered clay materials and the treatment compounds optionally used (e.g compatibilizing agents) are selected both to promote dispersion of the individual platelet particles into the polyester, to allow maximum barrier properties, minimum haze formation, and the formation of preforms by injection molding which are essentially non-crystalline in character. Said preform are subsequently formed into bottles which are essentialy crystalline in character.

The present invention will be further illustrated below by means of a number of preparation examples, which are given for purely indicative purposes and without any limitation of this invention.

### EXAMPLE 1

### Preparation of the Composite Material (Two-Steps Process)

The composite material was prepared as follows by using a production plant as reported in FIG. 1.

The compound used were the following:
Voridian® PET 9921P (Voridian): poly(ethylene terephthalate) having inherent viscosity of 0.77 dl/g determined according to standard ASTM D4603-91 as disclosed below and a melting temperature of 243° C.; and
Dellite 43B (Laviosa Chimica Mineraria): organo-modified montmorillonite; modified with dimethyl benzyl hydrogenated tallow ammonium ion, having an average particle size of 6 μm-8 μm.

150 kg of Voridian PET 9921P were dried in a molecular sieve Piovan DS313 drier having a 200 1 hopper, working at the following temperatures:
70° C. overnight;
heating at 120° C. and maintaining at this temperature for 2 hours;
heating at 140° C. and maintaining at this temperature for 2 hours.

A sample of the obtained poly(ethylene terephthalate) was subjected to moisture content analysis by means of a coulometric Karl Fisher method using a Metrohm 652 KF coulometer coupled with a Buchi TO-50 glass tube oven: the analysis was carried out at 180° C. and the sample showed a moisture content of 30 ppm.

Moreover, a sample of the obtained poly(ethylene terephthalate) was subjected to Differential Scanning Calorimetry (DSC) analysis in order to measure its melting enthalpy (Δ⁰Hₘ) using a Perkin Elmer DSC 7 differential scanning calorimeter. The temperature program below reported was applied to the sample to be analysed:
isotherm for 1 minute at 25° C.;
heating from 25° C. to 300° C. at a rate of 10° C./min.;
isotherm for 1 minute at 300° C.;
cooling from 300° C. to 25° C. at a rate of 10° C./min.;
isotherm for 1 minute at 25° C.;
heating from 25° C. to 300° C. at a rate of 10° C./min.

The poly(ethylene terephthalate) showed a melting enthalpy (Δ⁰Hₘ) of 60 J/g.

The dried poly(ethylene terephthalate) was fed to the feed hopper of a co-rotating twin-screw extruder Maris TM40HT having a nominal screw diameter of 40 mm and a L/D ratio of 48.

The feeding was carried out by means of a loss-in-weight gravimetric feeder.

The temperature profile in the zones of the extruder was the following:
Z₁=150° C.;
Z₂=280° C.;
Z₃=300° C.;
Z₄=280° C.;
Z₅=240° C.;
Z₆=240° C.;
Z₇=240° C.;
Z₈=240° C.;
Z₉=220° C.;
Z₁₀=220° C.;
Z₁₁=220° C.;
Z₁₂=220° C.;

The extruder die was kept at a temperature of 260° C.

The remaining working conditions were the following:
twin screw speed: 120 rpm;
feeding rate: 70 kg/h;
mechanical energy delivered to the system: 0.15 kWh/kg.

The molten poly(ethylene terephthalate) was discharged from the extruder in the form of continuous strands, was suddendly cooled in a water bath below its crystallization temperature to obtain a poly(ethylene terephthalate) in a substantially amorphous phase and subsequently granulated.

A sample of the obtained poly(ethylene terephthalate) in a substantially amorphous phase was dried in a molecular sieve Piovan DS313 drier having a 200 l hopper, working at the following temperatures:
70° C. overnight;
heating at 120° C. and maintaining at this temperature for 2 hours;
heating at 140° C. and maintaining at this temperature for 2 hours.

Subsequently, a sample of the dried poly(ethylene terephthalate) in a substantially amorphous phase was subjected to moisture content analysis by means of coulometric Karl Fisher method using a Metrohm 652 KF coulometer coupled with a Buchi TO-50 glass tube oven: the analysis was carried out a t 180° C. and the sample showed a moisture content of 40 ppm.

Moreover, a sample of the poly(ethylene terephthalate) in a substantially amorphous phase was subjected to Differential Scanning Calorimetry (DSC) analysis in order to measure its melting enthalpy (ΔHₘ) and its crystallization enthalpy (ΔH_{c}) using a Perkin Elmer DSC 7 differential scanning calorimeter. The temperature program below reported was applied to the sample to be analysed:
isotherm for 1 minute at 25° C.;
heating from 25° C. to 300° C. at a rate of 100° C./min.;
isotherm for 1 minute at 300° C.;
cooling from 300° C. to 250° C. at a rate of 10° C./min.;
isotherm for 1 minute at 25° C.;
heating from 25° C. to 300° C. at a rate of 10° C./min.

The obtained poly(ethylene terephthalate) in a substantially amorphous phase showed:
a melting enthalpy (ΔHₘ) of 37.6 J/g;
a crystallization enthalpy (ΔH_{c}) of 32.3 J/g; and
a % of crystallinity, determined by the following formula:
   % crystallinity=(ΔHₘ−ΔH_{c})/(Δ⁰Hₘ)*100
   of 8.83%.

At the same time, 20 kg of Dellite® 43B were dried, under vacuum, in an oven, at 80° C., for 12 hours.

The poly(ethylene terephthalate) in a substantially amorphous phase obtained as disclosed above and the Dellite® 43B were fed to the feed hopper of a second co-rotating twin-screw extruder Maris TM40HT having a nominal screw diameter of 40 mm and a L/D ratio of 48.

The feeding was carried out by means of a loss-in-weight gravimetric feeder.

The temperature profile in the zones of the extruder was the following:
Z1=30° C.;
Z₂=160° C.;
Z₃=160° C.;
Z₄=100° C.;
Z₅=100° C.;
Z₆=50° C.;
Z₇=50° C.;
Z₈=50° C.;
Z₉=50° C.;
Z₁₀=50° C.;
Z₁₁=50° C.;
Z₁₂=150° C.;

The extruder die was kept at a temperature of 260° C.

The remaining working conditions were the following:
twin screw speed: 500 rpm;
feeding rate: 40 kg/h;
mechanical energy delivered to the system: 0.9 kWh/kg.

The obtained composite material was discharged from the extruder in the form of continuous strands, was cooled in a water bath at room temperature and granulated.

### EXAMPLE 2

### Preparation of the Composite Material (One-Step Process)

The composite material was prepared as follows by using a production plant as reported in FIG. 2.

The compound used were the following:
Voridian® PET 9921P (Voridian): poly(ethylene terephthalate) having inherent viscosity of 0.77 dl/g determined according to standard ASTM D4603-91 as disclosed below and a melting temperature of 243° C.; and
Dellite® 43B (Laviosa Chimica Mineraria): organo-modified montmorillonite; modified. with dimethyl benzyl hydrogenated tallow ammonium ion, having an average particle size of 6 μm-8 μm.

150 kg of Voridian® PET 9921P were dried in a molecular sieve Piovan DS313 drier having a 200 l hopper, working at the following temperatures:
70° C. overnight;
heating at 120° C. and maintaining at this temperature for 2 hours;
heating at 140° C. and maintaining at this temperature for 2 hours.

A sample of the obtained poly(ethylene terephthalate) was subjected to moisture content analysis by means of a coulometric Karl Fisher method using a Metrohm 652 KF coulometer coupled with a Buchi TO-50 glass tube oven: the analysis was carried out at 180° C. and the sample showed a moisture content of 30 ppm.

At the same time, 20 kg of Dellite® 43B were dried, under vacuum, in an oven, at 80° C., for 12 hours.

The poly(ethylene terephthalate) was fed to the feed hopper of a co-rotating twin-screw extruder Maris TM40HT having a nominal screw diameter of 40 mm and a L/D ratio of 48.

The feeding was carried out by means of a loss-in-weight gravimetric feeder.

After the melting and the cooling of the poly (ethylene terephthalate), the Dellite® 43B was fed the second feed hopper.

The feeding was carried out by means of a loss-in-weight gravimetric feeder.

The temperature profile in the zones of the extruder was the following:
Z₁=230° C.;
Z₂=290° C.;
Z₃=300° C.;
Z₄=50° C.;
Z₅=50° C.;
Z₆=50° C.;
Z₇=50° C.;
Z₈=30° C.;
Z₉=30° C.;
Z₁₀=30° C.;
Z₁₁=30° C.;
Z₁₂=30° C.;

The extruder die was kept at a temperature of 250° C.

The remaining working conditions were the following:
twin screw speed: 400 rpm;
feeding rate: 40 kg/h;
mechanical energy delivered to the system: 0.8 kWh/kg.

The obtained composite material was discharged from the extruder in the form of continuous strands, was cooled in a water bath at room temperature and granulated.

### EXAMPLE 3

The composite materials obtained in Example 1 and in Example 2 were submitted to thermomechanical characterization using a DMTA analyser (Dynamic Mechanical Thermal Analyzer of Reometrics Inc.).

For this purpose, using the composite material of Example 1 and Example 2, plates with thickness of 1.0 mm were prepared by compression moulding at 265° C. and 200 bar after preheating for 4 minutes at the same temperature.

For comparative purposes, a plate of poly(ethylene terephthalate) as such was prepared as disclosed above.

Punched specimens with the following dimensions: 15 mm×6 mm×1.0 mm, were obtained from these plates, and were used for recording the variation in dynamic elastic modulus as a function of temperature. The obtained data are given in Table 1.

For this purpose, said punched specimens were fixed by clamps at both ends and submitted to tension with sinusoidal variation by means of the guide clamp operating at a frequency of oscillation of 1 Hz and in a temperature range of from −60° C. to +250° C., operating at a heating rate of 2° C./min. The elongation of the punched specimen is proportional to the current supplied to the vibrator connected to the clamp, whereas the load to which the punched specimen was subjected is proportional to its elongation and was detected by means of a transducer connected to the shaft of the vibrator clamp.

TABLE 1

| | −20° C. | 35° C. | 250° C. |
|---|---|---|---|
| SAMPLE | (Pa) | (Pa) | (Pa) |
| (A) | 2.2 × 10⁹ | 2.0 × 10⁹ | 1.5 × 10⁸ |
| (B) | 2.3 × 10⁹ | 2.1 × 10⁹ | 1.7 × 10⁸ |
| (C) * | 1.5 × 10⁹ | 1.4 × 10⁹ | 9.0 × 10⁷ |

* comparative;
(A): composite material of Example 1;
(B): composite material of Example 2;
(C): poly (ethylene terephthalate) as such.

The above data show that the composite materials according to the present invention [Samples (A) and (B)] are endowed with better dynamic elastic modulus with respect to the poly(ethylene terephthalate) as such [Sample (C)].

Measurements of Permeability

Table 2 gives the values of permeability to oxygen according to standard ASTM E96, measured at room temperature on plates with thickness of 200 μm obtained by compression moulding at 140° C. and 200 bar after preheating for 5 minutes at the same temperature.

TABLE 2

SAMPLES

| | (A) | (B) | (C) * |
|---|---|---|---|
| PERMEABILITY | 1.25 × 10⁻¹⁴ | 1.30 × 10⁻¹⁴ | 4.0 × 10⁻¹⁴ |
| (Ncc/Pa*sec*cm) | | | |

* comparative.

The data given above show that the composite materials according to the present invention [Samples (A) and (B)] are endowed with better barrier properties. In particular, the data in Table 2 show a decrease in permeability to oxygen of approx. 70% of samples (A) and (B) (containing 3 phr of Dellite® 43B) with respect to the poly(ethylene terephthalate) as such [sample (C)].

Measurements of Inherent Viscosity

The inherent viscosity (I.V.) was determined with standard ASTM D4603-91.

For this purpose, the inherent viscosity was measured in a mixture of 60% by weight of phenol and 40% by weight of 1,1,2,2-tetrachloroethane at a concentration of 0.5 g/100 ml (solvent) at 30° C. by means of Ubbelohde Type 1B viscosimeter in a MGW Lauda thermostat. The obtained data are given in Table 3.

TABLE 3

| | SAMPLES | | |
|---|---|---|---|
| | (A) | (B) | (C) * |
| INHERENT VISCOSITY | 0.70 | 0.68 | 0.77 |
| (dl/g) | | | |

* comparative.

The data given above show that the inherent viscosity of the composite materials according to the present invention [samples (A) and (B)] are not negatively affected: this show that the process of the present invention do not cause an excessive degradation of the poly(ethylene terephthalate).

1-48. (canceled)

49. A process for producing a composite material comprising the following steps:
(a) melting at least one polyester having an inherent viscosity higher than or equal to 0.5 dl/g;
(b) cooling said polyester to obtain a polyester having a crystallinity lower than 30%; and
(c) mixing at least one layered clay material with the polyester obtained in step (b) so as to obtain the composite material.

50. The process for producing a composite material according to claim 49, wherein the polyester of step (a) has an inherent viscosity of 0.6 dl/g to 1.2 dg/l.

51. The process for producing a composite material according to claim 49, wherein the polyester obtained in step (b) has a crystallinity of 1% to 20%.

52. The process for producing a composite material according to claim 49, wherein the ratio between the inherent viscosity of the composite material and the inherent viscosity of the starting polyester used in step (a) is not higher than 1.

53. The process for producing a composite material according to claim 52, wherein the ratio between the inherent viscosity of the composite material and the inherent viscosity of the starting polyester used in step (a) is 0.7 to 0.9.

54. The process for producing a composite material according to claim 49, comprising carrying out the process in one-step or in two-steps.

55. The process for producing a composite material according to claim 49, wherein said melting step (a) is carried out at a temperature of 150° C. to 350° C.

56. The process for producing a composite material according to claim 55, wherein said melting step (a) is carried out at a temperature of 200° C. to 300° C.

57. The process for producing a composite material according to claim 49, wherein said melting step (a) is carried out for 5 seconds to 15 minutes.

58. The process for producing a composite material according to claim 57, wherein said melting step (a) is carried out for 10 seconds to 10 minutes.

59. The process for producing a composite material according to claim 49, comprising carrying out the process in one-step wherein said cooling step (b) is carried out to reach a temperature higher than the crystallization temperature of the polyester used in step (a), but lower than the melting temperature (Tₘ) of the polyester used in step (a).

60. The process for producing a composite material according to claim 59, wherein said cooling step (b) is carried out at a temperature of (Tₘ-120° C.) to (Tₘ-20° C.).

61. The process for producing a composite material according to claim 60, wherein said cooling step (b) is carried out at a temperature of (Tₘ-100° C.) to (Tₘ-40° C.).

62. The process for producing a composite material according to claim 59, wherein said cooling step (b) is carried out for 2 seconds to 10 minutes.

63. The process for producing a composite material according to claim 62, wherein said cooling step (b) is carried out for 5 seconds to 5 minutes.

64. The process for producing a composite material according to claim 59, wherein said cooling step (b) is carried out directly in the mixing device used in step (a).

65. The process for producing a composite material according to claim 49 comprising carrying out the process in two-steps, wherein said cooling step (b) is carried out to reach a temperature lower than the crystallization temperature (T_{c}) of the polyester used in step (a).

66. The process for producing a composite material according to claim 65, wherein said cooling step (b) is carried out at a temperature of (T_{c}-120° C.) to (T_{c}-20° C.).

67. The process for producing a composite material according to claim 66, wherein said cooling step (b) is carried out at a temperature of (T_{c}-100° C.) to (T_{c}-40° C.).

68. The process for producing a composite material according to claim 65, wherein and cooling step (b) is carried out for 2 seconds to 60 seconds.

69. The process for producing a composite material according to claim 68, wherein said cooling step (b) is carried out for 3 seconds to 30 seconds.

70. The process for producing a composite material according to claim 49, wherein said mixing step (c) is carried out at a temperature of 20° C. to 160° C.

71. The process for producing a composite material according to claim 70, wherein said mixing step (c) is carried out at a temperature of 30° C. to 120° C.

72. The process for producing a composite material according to claim 49, wherein said mixing step (c) is carried out for 2 seconds to 15 minutes.

73. The process for producing a composite material according to claim 72, wherein said mixing step (c) is carried out for 3 seconds to 10 minutes.

74. The process for producing a composite material according to claim 49, wherein said process comprises a crystallization step (d).

75. The process for producing a composite material according to claim 74, wherein said crystallization step (d) is carried out by cooling the composite material obtained in step (c) at a temperature from the glass transition temperature to the crystallization temperature of the polyester obtained in step (b), with a cooling speed of 1° C./min to 20° C./min.

76. The process for producing a composite material according to claim 75, wherein said crystallization step (d) is carried out with a cooling speed of 2° C./min to 10° C./m in.

77. The process for producing a composite material according to claim 49, wherein the polyester used in step (a) has a melting point higher than 200° C.

78. The process for producing a composite material according to claim 77, wherein the polyester used in step (a) has a melting point of 210° C. to 270° C.

79. The process for producing a composite material according to claim 49, wherein the polyester used in step (a) has a melting enthalpy higher than or equal to 10 J/g.

80. The process for producing a composite material according to claim 79, wherein the polyester used in step (a) has a melting enthalpy of 15 J/g to 180 J/g.

81. The process for producing a composite material according to claim 49, wherein the polyester used in step (a) is selected from polyesters comprising at least one dibasic acid and at least one glycol.

82. The process for producing a composite material according to claim 81, wherein the polyester used in step (a) is selected from: poly(ethylene terephthalate), poly(trimethylene terephthalate), poly (butylene terephthalate), poly(naphthalene terephthalate), copolymers thereof or mixtures thereof.

83. The process for producing a composite material according to claim 82, wherein the polyester used in step (a) is poly(ethylene terephthalate).

84. The process for producing a composite material according to claim 49, wherein the layered material used in step (c) has an individual layer thickness of 0.01 nm to 30 nm.

85. The process for producing a composite material according to claim 84, wherein the layered material used in step (c) has an individual layer thickness of 0.05 nm to 15 nm.

86. The process for producing a composite material according to claim 49, wherein the layered material used in step (c) is selected from natural clays, montmorillonite, saponite, hectorite, mica, vermiculite, bentonite, nontronite, beidellite, volkonskoite, magadite, kenyaite, or mixtures thereof; synthetic clays, synthetic mica, synthetic saponite, synthetic hectorite, or mixtures thereof; modified clays, fluorinated montmorillonite, fluorinated mica, or mixtures thereof.

87. The process for producing a composite material according to claim 86, wherein the layered material used in step (c) is montmorillonite.

88. The process for producing a composite material according to claim 49, wherein the layered material used in step (c) is treated with a compatibilizing agent capable of generating organic cations, said compatibilizing agent being selected from quaternary ammonium or phosphonium salts having general formula (I): 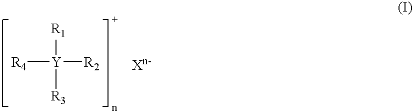
wherein:
Y represents N or P;
R₁, R₂, R₃, and R₄, which may be identical or different, represent organic and/or oligomeric ligands or a hydrogen atom;
Xⁿ⁻ represents an anion, chlorine ion, sulphate ion, phosphate ion, hydroxide ion, or acetate ion; and
n represents 1, 2 or 3.

89. The process for producing a composite material according to claim 88, wherein said compatibilizing agent is selected from: dimethyl benzyl hydrogenated tallow ammonium, hexyl benzyl dimethyl ammonium, benzyl trimethyl ammonium, butyl benzyl dimethyl ammonium, or mixtures thereof.

90. The process for producing a composite material according to claim 49, wherein the layered material used in step (c) is selected from layered double hydroxides.

91. The process for producing a composite material according to claim 49, wherein the layered material used in step (c) is present in the composite material in an amount of 0.01 phr to 25 phr.

92. The process for producing a composite material according to claim 91, wherein the layered material used in step (c) is present in the composite material in an amount of 0.5 phr to 15 phr.

93. A manufactured product comprising a composite material obtained by the process according to claim 49.

94. The manufactured product according to claim 93, comprising a monolayer manufactured product.

95. The manufactured product according to claim 93, comprising food or beverage containers.

96. The manufactured product according to claim 95, wherein said food or beverage container is a bottle.
